(19) United States
(12) Patent Application Publication
(10) Pub. No.: US 2006/0067785 A1
(43) Pub. Date: Mar. 30, 2006

(54) Tubular coupler for concrete reinforcing bars

(75) Inventor: Steven E. Holdsworth, Centerville, OH (US)

Correspondence Address: Alan F. Meckstroth;JACOX, MECKSTROTH & JENKINS, Suite 2, 2310 Far Hills Building, Dayton, OH, 45419-1575, US

(73) Assignee: Barsplice Products, Inc.

(21) Appl. No.: 10/955,410

(22) Filed: Sep. 30, 2004

(51) Int. Cl. F16D 1/00

(52) U.S. Cl. 403/306

(57) ABSTRACT

An elongated tubular steel body has a longitudinally extending internal seat for engaging an end portion of at least one generally cylindrical concrete reinforcing bar or rebar having a center axis. A series of longitudinally spaced and peripherally spaced threaded holes are formed within the body in opposing relation to the seat, and a screw is threaded into each hole. The axes of the holes and screws define planes which converge toward the center axis of the reinforcing bar and are arranged in alternating staggered relation along the length of the body. The tubular body may have different cross-sectional shapes or profiles, and the seat may be formed by converging wedging surfaces or longitudinally extending circumferentially spaced rails each having teeth engaging the body and reinforcing bar.

### BACKGROUND OF THE INVENTION

The present invention relates to elongated tubular metal couplers for concrete reinforcing bars commonly referred to as “rebars”, and which have longitudinally spaced screws for engaging and gripping the rebars, for example, as disclosed in U.S. Pat. No. 5,664,902, U.S. Pat. No. 5,909,980 and U.S. Pat. No. 6,202,282 which issued to the assignee of the present invention and the disclosures of which are herein incorporated by reference. Such type of rebar couplers are also disclosed in U.S. Pat. No. 5,046,878 and British patent application No. GB2388125. In this type of rebar coupler, it has been found highly desirable to shorten the length of the tubular coupler body without decreasing tensile strength of the rebar and coupler assembly. Shortening the length of the body reduces the weight of the coupler and reduces the space occupied by the coupler. A shorter and lighter weight coupler also provides greater accessibility for connecting the couplers to the rebars and minimizes the obstruction to the flow of concrete around the rebars and couplers. A reduction in the length of the coupler body and in the total weight of the coupler also makes the coupler easier and more convenient to handle, more economical in construction and reduces the cost for shipping the coupler to a construction or job site. As a result, a reinforced concrete structure may be built more economically. Moreover, a shorter length coupler is desirable during repair of a reinforced concrete structure since less concrete needs to be chipped away or removed to expose rebars which require repair or replacement using couplers. The structural integrity of the remaining concrete is thereby better maintained, and there is less of a safety hazard from rebars that protrude from the concrete.

### SUMMARY OF THE INVENTION

The present invention is directed to an improved coupler for positively connecting a generally cylindrical concrete reinforcing bar or rebar to another rebar in end-to-end relation or to another element such as a termination head or end anchorage member. The coupler of the invention provides all of the desirable features mentioned above, including a substantially shorter length coupler body and a substantially lower weight while maintaining high gripping forces on the rebar, with the result that the assembly of the coupler and rebar has no reduction in tensile strength. In addition, the shorter length coupler of the invention significantly reduces the manufacturing cost of the coupler and provides greater access to the area surrounding the coupler and rebar so that the coupler may be attached to the rebars more conveniently and there is less restriction to the flow of concrete around the coupler and the attached rebar or rebars. The lighter weight coupler of the invention is also easier and more convenient to handle, especially with couplers for the larger diameter reinforcing bars, and significantly reduces the cost of shipping the couplers to a construction site.

In accordance with an illustrated embodiment of the invention, the coupler of the invention includes an elongated tubular metal body having a longitudinally extending internal seat for engaging an end portion of a rebar on one side of a first reference plane extending through the center axis of the rebar. A series of threaded holes are formed within the body in generally opposing relation to the seat, and the holes have axes arranged in longitudinally spaced and peripherally spaced relation on opposite sides of a second reference plane also extending through the axis of the rebar. Screws are threaded into the holes and have inner end portions which penetrate and deform the end portion of the rebar for positively gripping the rebar and forcing the rebar against the seat to form a high strength connection between the coupler body and the end portion of the rebar. The internal seat may be formed by converging wedging surfaces or by longitudinally extending spaced rails having teeth which engage the rebar and the coupler body, and the tubular coupler body may have different cross-sectional profiles.

Other features and advantages of the invention will be apparent from the following description, the accompanying drawings and the appended claims.

### BRIEF DESCRIPTION OF THE DRAWINGS

FIG. 1 is a side elevational view of a coupler constructed in accordance with the invention and ready to connect opposing end portions of two axially aligned rebars;

FIG. 2 is a section of the coupler taken generally on the line 2-2 of FIG. 1 and before the coupler is secured to the two rebars;

FIG. 3 is a section similar to FIG. 2 and showing the coupler after being secured to the rebars;

FIG. 4 is an axial section taken generally on the line 4-4 of FIG. 3;

FIGS. 5 and 6 illustrate the steps for forming the tubular coupler body shown in FIGS. 1-3;

FIGS. 7 and 8 are sections similar to FIGS. 2 and 3 and showing a modification of a coupler constructed in accordance with the invention; and

FIGS. 9 and 10 are sections similar to FIGS. 7 and 8 and showing a further modification of a coupler constructed in accordance with the invention.

### DESCRIPTION OF THE PREFERRED EMBODIMENT

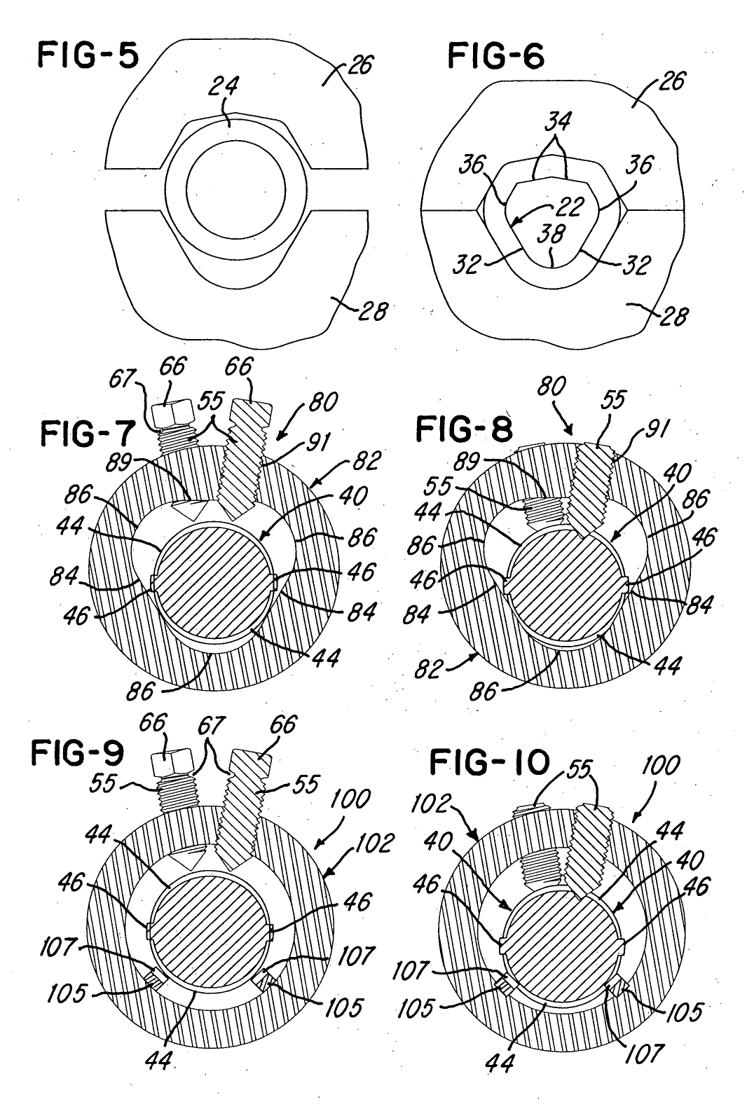

FIG. 1 illustrates a coupler 20 constructed in accordance with the invention and which includes an elongated tubular steel body 22 constructed from ductile seamless cylindrical tubing 24 (FIG. 5) which is deformed or forged between a pair of forging dies 26 and 28 to form the profile of the tubular body 22, as shown in FIG. 6. This profile has a substantially uniform wall thickness and has internal converging flat surfaces 32 forming a wedging seat as also disclosed in above mentioned U.S. Pat. No. 6,202,282. The coupler body 22 also has slightly angled internal flat surfaces 34 which generally oppose the converging and wedging surfaces 32 and are connected to the surfaces 32 by curved or part-cylindrical surfaces 36. The converging and wedging surfaces 32 are connected by an inner part-cylindrical surface 38.

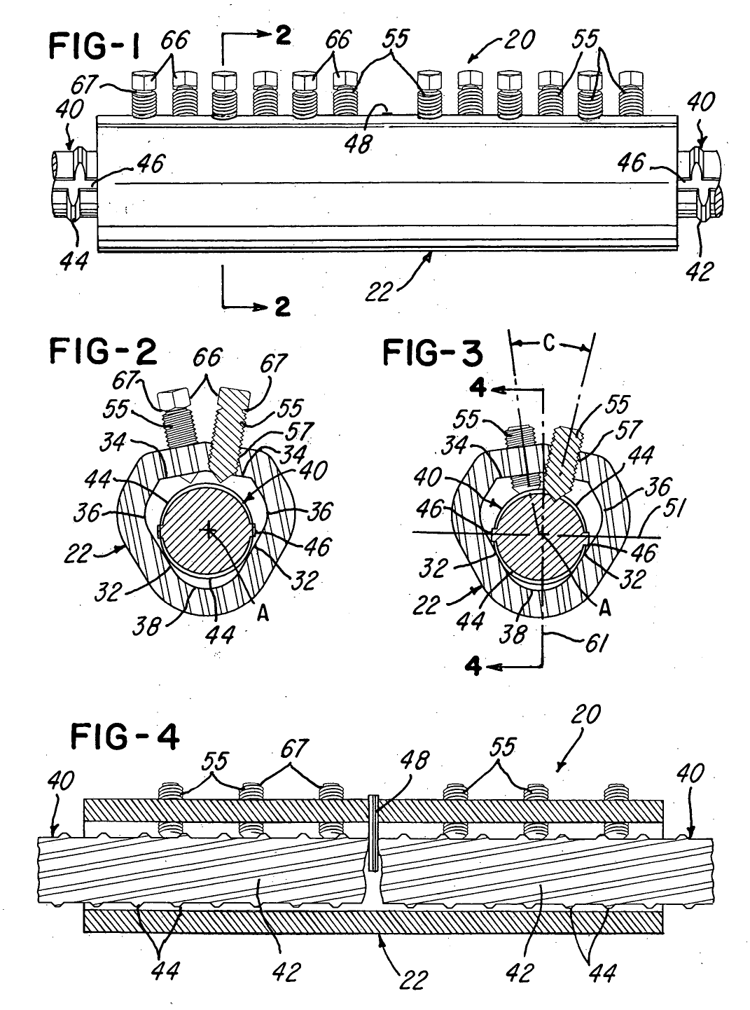

As shown in FIGS. 1 and 4, a pair or set of axially aligned concrete reinforcing bars or rebars 40 have opposing end portions 42 which are inserted and received within the coupler body 22 and which engage the wedging seat formed by the converging inner flat surfaces 32. Commonly, the rebars 40 have longitudinally spaced and circumferentially extending ribs 44 (FIG. 1) and also a pair of longitudinally extending and diametrically opposite ribs 46. The inner end surfaces of the rebars 40 engage a stop pin 48 (FIG. 4) extending radially through the tubular steel body 22. The rebars 40 have a common center axis A (FIG. 3), and a reference plane 51 extends through the axis A and through the opposite longitudinally extending ribs 46. As shown in FIGS. 2 and 3, the ribs 44 on the end portions 42 of the rebars 40 engage the converging wedging surfaces 32 of the coupler body 22 below or on one side of the reference plane 51.

In accordance with one embodiment of the invention, the opposing end portions 42 of the rebars 40 are positively retained within the coupler body 22 by a series of longitudinally spaced and peripherally spaced screws 55 which extend through corresponding threaded holes 57 having axes perpendicular to the inner flat surfaces 34 of the coupler body 22. Thus the axes of the screws 55 and threaded holes 57 are laterally offset from a reference plane 61 which is perpendicular to the reference plane 51. Preferably, the axes of the laterally offset screws 55 and holes 57 converge towards the axis A of the rebars 40 and alternate in staggered relation along the length of the coupler body 22. As shown in FIGS. 2 and 3, the screws 55 are preferably arranged in two converging rows, and the screw axes define converging planes with an angle C between 10° and 40° and preferably on the order of 20°. However, the holes and screws 55 do not have to be in rows.

As apparent from FIGS. 2 and 3, each of the screws 55 has a hexagonal or square head portion 66 projecting from a peripheral groove 67. When the screws 55 are tightened manually or by means of a power operated impact wrench, the inner end portions of the screws penetrate into the rebars 40 and force the rebar end portions 42 into the seat formed by the wedging surfaces 32, as shown in FIG. 3. After a predetermined torque is applied to the head portion 66 of each screw 55, the head portion 66 shears off to provide a visual indication that the predetermined torque has been applied.

By providing the coupler body 22 with the longitudinally spaced and laterally offset threaded holes and corresponding screws 55, it has been found that the overall length of the coupler body 22 may be substantially shortened without reducing the tensile strength of the coupler 20 and the connected rebars 40. For example, by constructing the coupler 20 as disclosed in FIGS. 1-4 instead of having a single row of screws as disclosed in the above mentioned U.S. Pat. No. 6,202,282, the coupler body 22 may be shortened from a length of about 40 inches to about 24 inches for a No. 18 rebar having an across-rib diameter of about 2⅝ inches. This substantial length reduction has been obtained with the use of 32 screws 55 and without any reduction in the tensile strength of the rebar and coupler assembly.

Moreover, the length reduction of the coupler body 22 from about 40 inches to about 24 inches for a No. 18 rebar results in a weight reduction for the coupler 20 from about 110 pounds to under 60 pounds. An arrangement of the axially spaced and peripherally spaced holes 57 and screws 55 with their axes in three converging rows instead of two converging rows as shown in FIGS. 2 and 3, provides for a further reduction in the length and weight of the coupler body 22. However, the small additional reduction does not normally justify the additional row of screws 55. Furthermore, there is inconvenience in obtaining access to the additional row of screws at a job site with a power operated impact torque wrench.

Referring to FIGS. 7 and 8, a coupler 80 includes a coupler body 82 which is formed from a steel extrusion having a cylindrical outer surface and a generally triangular inner opening formed in part by converging flat inner surfaces 84 forming a wedging seat and connected by a part-cylindrical surface 86 having a radius of curvature somewhat less then the radius of the rebar 40. Two additional part-cylindrical surfaces 86 connect the converging flat and wedging surfaces 84 to an inner flat surface 89 through which the two rows of converging holes 91 are formed for receiving the corresponding screws 55.

Thus FIG. 7 illustrates another form of coupler body which may be used for connecting end portions of rebars 40 and which is particularly suited for rebars having a smaller diameter, for example, No. 14 rebars having an across-rib diameter of about 1⅞ inch. FIG. 8 illustrates the coupler 80 after it has been secured to a rebar 40 by the converging rows of screws 55 and illustrating the penetration of the inner tips of the screws 55 into the rebar and the penetration of the ribs 44 of the rebar into the converging wedging surfaces 84 forming the seat for the rebar.

FIGS. 9 and 10 illustrate another form or modification of a rebar coupler 100 constructed in accordance with the invention and which incorporates a tubular steel coupler body 102 having a cylindrical outer surface and a cylindrical inner surface. In this embodiment, the gripping seat for a rebar 40 or two aligned rebars is formed by a pair of axially extending and circumferentially spaced internal rails 105 which have opposite end portion welded to the steel body 102. Each of the rails 105 has longitudinally spaced V-shaped inner teeth 107 which engage the outer surface of the rebar 40 and longitudinally spaced V-shaped outer teeth (not shown) which engage the inner surface of the steel body 102. The use of rails having longitudinally spaced teeth such as the rails 105 to form a seat for a rebar 40, or two rebars 40, is disclosed in above-mentioned U.S. Pat. No. 5,046,878 and permits the use of conventional steel tubing to form the coupler body 102. As illustrated in FIG. 10, when the laterally and longitudinally spaced screws 55 are tightened, the inner tips of the screws 55 penetrate the outer surface of the rebar 40, and the teeth on the rails 105 penetrate both the outer surface of the rebar 40 and the inner surface of the coupler body 102.

As mentioned above, a rebar coupler constructed in accordance with the present invention enables the coupler body to be made with a substantially shorter length and with a substantially lesser weight without reducing the tensile strength of the coupler and the attached rebars. As a result, a coupler constructed in accordance with the invention has a more economical construction and is more convenient to handle, ship and use, especially when used to connect with larger diameter rebars. The substantially shorter length and substantially lower weight of the rebar coupler are especially desirable for reinforced concrete structures which use a large number of concentrated rebars and couplers, such as, for example, a reinforced concrete structure for a nuclear power plant. The shorter couplers significantly reduces the cost for constructing the concrete structure.

While the methods and forms of coupler herein described constitute preferred embodiments of the invention, it is to be understood that the invention is not limited to the precise methods and forms described, and that changes may be made therein without departing from the scope and spirit of the invention as defined in the appended claims.

What is claimed is:

1. In combination with a generally cylindrical elongated concrete reinforcing bar having a center axis, an improved coupler positively gripping an end portion of said bar, said coupler comprising an elongated tubular metal body, a longitudinally extending seat within said body and engaging said end portion of said bar on one side of a first reference plane extending through said axis of said bar, a series of longitudinally spaced threaded holes within said body in generally opposing relation to said seat, said holes having axes arranged in peripherally spaced relation on opposite sides of a second reference plane also extending through said axis of said bar, a corresponding series of screws threaded into said holes and having inner end portions penetrating and deforming said end portion of said bar, and said end portion of said bar positively engages said seat in response to substantial forces exerted by said screws to form a high strength positive connection between said body and said end portion of said reinforcing bar.

2. A coupler as defined in claim 1 wherein said axes of said threaded holes and said screws converge toward said axis of said reinforcing bar.

3. A coupler as defined in claim 2 wherein said axes of said holes and said screws define a plane converging at an angle between ten degrees and forty degrees with respect to said second reference plane.

4. A coupler as defined in claim 1 wherein said axes of said threaded holes and said screws alternate in staggered relation on opposite sides of said second reference plane along the length of said coupler body.

5. A coupler as defined in claim 1 wherein said threaded holes and said screws are arranged in a plurality of peripherally spaced and axially extending rows with said axes of said holes in each said row defining a plane extending at an acute angle with respect to said second reference plane.

6. A coupler as defined in claim 5 wherein said acute angle is within a range of five degrees and twenty degrees.

7. A coupler as defined in claim 5 wherein said acute angle is about ten degrees.

8. A coupler as defined in claim 1 wherein said seat within said body comprises longitudinally extending and converging wedging surfaces.

9. A coupler as defined in claim 1 wherein said seat within said body comprises a plurality of longitudinally extending spaced rails each having longitudinally spaced teeth engaging said end portion of said reinforcing bar.

10. A coupler as defined in claim 1 wherein said tubular metal body has a generally diamond-shaped cross-sectional configuration with substantially flat outer surfaces substantially perpendicular to said axes of said holes and said screws.

11. A coupler as defined in claim 1 wherein said tubular metal body has inner surfaces defining a generally triangular cross-sectional configuration with rounded corner surfaces.

12. A coupler as defined in claim 1 wherein said tubular metal body has substantially cylindrical inner and outer surfaces.

13. In combination with two opposing generally cylindrical elongated concrete reinforcing bars having a substantially common axis, an improved coupler positively gripping opposing end portions of said bars, said coupler comprising an elongated tubular metal body, a longitudinally extending seat within said body and engaging said end portions of said bars on one side of a first reference plane extending through said common axis of said bars, a series of longitudinally spaced threaded holes within said body in generally opposing relation to said seat, said holes having axes arranged in peripherally spaced relation on opposite sides of a second reference plane also extending through said common axis of said bars, a corresponding series of screws threaded into said holes and having inner end portions penetrating and deforming said end portions of said bars, and said end portions of said bars positively engage said seat in response to substantial forces exerted by the longitudinally and peripherally spaced said screws to form a high strength positive connection between said body and said opposing end portions of said reinforcing bars.

14. A coupler as defined in claim 13 wherein said axes of said threaded holes and said screws converge toward said common axis of said reinforcing bars.

15. A coupler as defined in claim 14 wherein said axes of said holes and said screws converge at an angle between ten degrees and forty degrees with respect to said second reference plane.

16. A coupler as defined in claim 13 wherein said axes of said threaded holes and said screws alternate in staggered relation on opposite sides of said second reference plane along the length of said coupler body.

17. A coupler as defined in claim 13 wherein said threaded holes and said screws are arranged in a plurality of peripherally spaced and axially extending rows with said axes of said holes in each said row defining a plane extending at an acute angle with respect to said second reference plane.

18. A coupler as defined in claim 17 wherein said acute angle is within a range of five degrees and twenty degrees.

19. A coupler as defined in claim 17 wherein said acute angle is about ten degrees.

20. A coupler as defined in claim 13 wherein said seat within said body comprises longitudinally extending and converging wedging surfaces.

21. A coupler as defined in claim 13 wherein said seat within said body comprises a plurality of longitudinally extending spaced rails each having longitudinally spaced teeth engaging said end portions of said reinforcing bars.

22. A coupler as defined in claim 13 wherein said body has a substantially uniform wall thickness.
